(19) United States
(12) Patent Application Publication
(10) Pub. No.: US 2017/0048291 A1
(43) Pub. Date: Feb. 16, 2017

(54) SYNCHRONISING PLAYING OF STREAMING CONTENT ON PLURAL STREAMING CLIENTS

(71) Applicant: TELEFONAKTIEBOLAGET LM ERICSSON (PUBL), Stockholm (SE)

(72) Inventors: Stefan JACOBSSON, Stocksund (SE); Erik NORDLUND, Hägersten (SE)

(73) Assignee: TELEFONAKTIEBOLAGET LM ERICSSON (PUBL), Stockholm (SE)

(21) Appl. No.: 15/118,717

(22) PCT Filed: Feb. 14, 2014
(86) PCT No.: PCT/SE2014/050185

§ 371 Date: Aug. 12, 2016

(51) Int. Cl. H04L 29/06

(52) U.S. Cl. CPC H04L 65/4076; H04L 65/602

(57) ABSTRACT

It is presented a method for synchronising playing of streaming content between an initiating streaming client and a following streaming client. The method is performed by the initiating streaming client and comprises the steps of: initiating streaming of a media stream of the streaming content to the initiating streaming client; determining a session start time after which the media stream is to be started to be played by any client having access to the session start time; and sending a streaming info message for distribution to the following streaming client, the streaming info message comprising an identifier of the streaming content and the session start time.

### TECHNICAL FIELD

The invention relates to synchronising playing of streaming content between an initiating streaming client and a following streaming client.

### BACKGROUND

There is a dramatic shift in how media content is consumed. Traditionally, media content has been consumed using broadcast or physical content distribution. When it comes to audio, this implies radio broadcasting and records, CDs (Compact Discs), audio cassettes, etc. When it comes to video (typically combined with audio), this implies television broadcasting and video cassettes or optical discs.

When it comes to broadcasting, since the content is more or less simultaneously broadcasted within a broadcast network, or even across different broadcast networks, this allows two or more separate content consumers to synchronously enjoy the media content. In this way, two people being located in different location could e.g. talk over the phone or chat using instant messaging while referring to the content, e.g. during sports events or other media content of mutual interest. This adds a strong social dimension of enjoying the content even when two people are in different locations.

However, people now more and more enjoy on-demand streaming content using services such as those provided by www.youtube.com, retrieved on 10 Feb. 2014, www.netflix.com, retrieved on 10 Feb. 2014, etc. as well as on-demand streaming content from traditional broadcast networks.

When content is enjoyed on-demand, the social dimension of enjoying the content even when two people are in different locations is not naturally available.

### SUMMARY

It is an object to improve synchronisation of streaming content between streaming clients.

According to a first aspect, it is presented a method for synchronising playing of streaming content between an initiating streaming client and a following streaming client. The method is performed by the initiating streaming client and comprises the steps of: initiating streaming of a media stream of the streaming content to the initiating streaming client; determining a session start time after which the media stream is to be started to be played by any client having access to the session start time; and sending a streaming info message for distribution to the following streaming client, the streaming info message comprising an identifier of the streaming content and the session start time. This synchronisation of streams across multiple streaming clients enables a social aspect of consuming streaming content which hitherto has only been available for broadcast or multicast content. It is to be noted that this method can be extended to cover two, three or more following streaming clients.

The step of determining a session start time may comprise determining the session start time by adding a guard time period to a current time. By setting the guard time appropriately, this allows the following client to setup its media stream so that is ready to play the content by the time the session start time occurs.

The step of determining a session start time may comprise determining the session start time to be a time of when the media stream becomes available to the initiating streaming client. In other words, the session start time can be set to the time at which a particular event starts, such as a sporting event, etc.

The method may comprise the step of: starting to play the media stream once the session start time has passed.

The method may comprise the step of: determining when a first handshake message has been received, the first handshake message indicating that the following streaming client has received the streaming info message. This increases reliability of communication.

The method may comprise the step of: returning to the step of determining a session start time when the first handshake message has not been received within a specific time. In other words, when the first handshake message is not received, the initiating streaming client determines a new session start time to for a new attempt to allow the following streaming client to start playing at the same time as the initiating streaming client.

The method may comprise the steps of: receiving user input to pause the media stream; sending a pause message for distribution to the following streaming client, the pause message comprising an identifier of the streaming content. This provides synchronised pausing, which adds a whole new level of enjoying the content across remote locations. In other words, if one user (of the streaming client or the following client) needs to pause the streaming content, this can be done while still keeping the streaming content across clients synchronised.

The method may comprise the step of: determining when a second handshake message has been received, the second handshake message indicating that the following streaming client has received the pause message. This increases reliability of communication also for the pausing.

The method may comprise the step of: pausing the media stream.

The step of determining a session start time may comprise determining the session start time to be the current time. This will allow the initiating streaming client to start playing the content quickly which increases responsiveness for the user of the initiating streaming client. This may cause the following streaming client to not being able to start playing at the same time. However, the following streaming client can skip to a synchronised point in the streaming content, determined by subtracting its current time with the session start time.

The media stream may be a unicast media stream.

According to a second aspect, it is presented an initiating streaming client for synchronising playing of streaming content between the initiating streaming client and a following streaming client. The initiating streaming client comprises: a processor; and a memory storing instructions that, when executed by the processor, causes the initiating streaming client to: initiate streaming of a media stream of the streaming content to the initiating streaming client; determine a session start time after which the media stream is to be started to be played by any client having access to the session start time; and send a streaming info message for distribution to the following streaming client, the streaming info message comprising an identifier of the streaming content and the session start time.

The instructions to determine a session start time may comprise instructions that, when executed by the processor, causes the initiating streaming client to determine the session start time by adding a guard time period to a current time.

The instructions to determine a session start time may comprise instructions that, when executed by the processor, causes the initiating streaming client to determine the session start time to be a time of when the media stream becomes available to the initiating streaming client.

The initiating streaming client may comprise instructions that, when executed by the processor, causes the initiating streaming client to start to play the media stream once the session start time has passed.

The initiating streaming client may comprise instructions that, when executed by the processor, causes the initiating streaming client to: determine when a first handshake message has been received, the first handshake message indicating that the following streaming client has received the streaming info message within a specific time.

The initiating streaming client may comprise instructions that, when executed by the processor, causes the initiating streaming client to: re-execute the instructions to determine a session start time when the first handshake message has not been received.

The initiating streaming client may comprise instructions that, when executed by the processor, causes the initiating streaming client to: receive user input to pause the media stream; send a pause message for distribution to the following streaming client, the pause message comprising an identifier of the streaming content.

The initiating streaming client may comprise instructions that, when executed by the processor, causes the initiating streaming client to: determine when a second handshake message has been received, the second handshake message indicating that the following streaming client has received the pause message.

The initiating streaming client may comprise instructions that, when executed by the processor, causes the initiating streaming client to: pause the media stream.

The instructions to determine a session start time comprise instructions that, when executed by the processor, causes the initiating streaming client to determine the session start time to be the current time.

The media stream may be a unicast media stream.

According to a third aspect, it is presented an initiating streaming client comprising: means for initiating streaming of a media stream of the streaming content to the initiating streaming client; means for determining a session start time after which the media stream is to be started to be played by any client having access to the session start time; and means for sending a streaming info message for distribution to a following streaming client for synchronising playing of streaming content between the initiating streaming client and the following streaming client, the streaming info message comprising an identifier of the streaming content and the session start time.

The means for determining a session start time may comprise means for determining the session start time by adding a guard time period to a current time.

The means for determining a session start time may comprise means for determining the session start time to be a time of when the media stream becomes available to the initiating streaming client.

The initiating streaming client may comprise means for starting to play the media stream once the session start time has passed.

The initiating streaming client may comprise means for determining when a first handshake message has been received, the first handshake message indicating that the following streaming client has received the streaming info message.

The initiating streaming client may comprise means for re-executing the determining a session start time when the first handshake message has not been received within a specific time.

The initiating streaming client may comprise means for receiving user input to pause the media stream; and means for sending a pause message for distribution to the following streaming client, the pause message comprising an identifier of the streaming content.

The initiating streaming client may comprise means for determining when a second handshake message has been received, the second handshake message indicating that the following streaming client has received the pause message.

The initiating streaming client may comprise means for pausing the media stream.

The means for determining a session start time may comprise means for determining the session start time to be the current time.

The media stream may be a unicast media stream.

According to a fourth aspect, it is presented a computer program for synchronising playing of a media stream between an initiating streaming client and a following streaming client. The computer program comprises computer program code which, when run on the initiating streaming client causes the initiating streaming client to: initiate streaming of the media stream to the initiating streaming client; determine a session start time after which the media stream is to be started to be played by any client having access to the session start time; and send a streaming info message for distribution to the following streaming client, the streaming info message comprising an identifier of the media stream and the session start time.

According to a fifth aspect, it is presented a computer program product comprising a computer program according to the fourth aspect and a computer readable means on which the computer program is stored.

It is to be noted that any feature of the first, second, third, fourth and fifth aspects may, where appropriate, be applied to any other of these aspects.

It is to be noted that whenever the phrase “initiating streaming client” is used herein, it should be construed as the streaming client which determines the session start time. Whenever the phrase “following streaming client” is used herein, it is to be construed as a streaming client which is provided by a session start time for timing of playing a streaming content. In other words, a particular streaming client can be an initiating streaming client at one point in time and a following streaming client at another point in time.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment where embodiments presented herein may be applied;

FIGS. 2A-C are sequence diagrams illustrating communication between the components of FIG. 1 for synchronising playing of streaming content in various embodiments;

FIGS. 3A-B are flow charts illustrating embodiments of methods for synchronising playing of streaming content;

FIG. 4 is a schematic diagram showing some components of a streaming client of FIG. 1;

FIG. 5 is a schematic diagram showing functional modules of the streaming client of FIGS. 1 and 4; and

FIG. 6 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

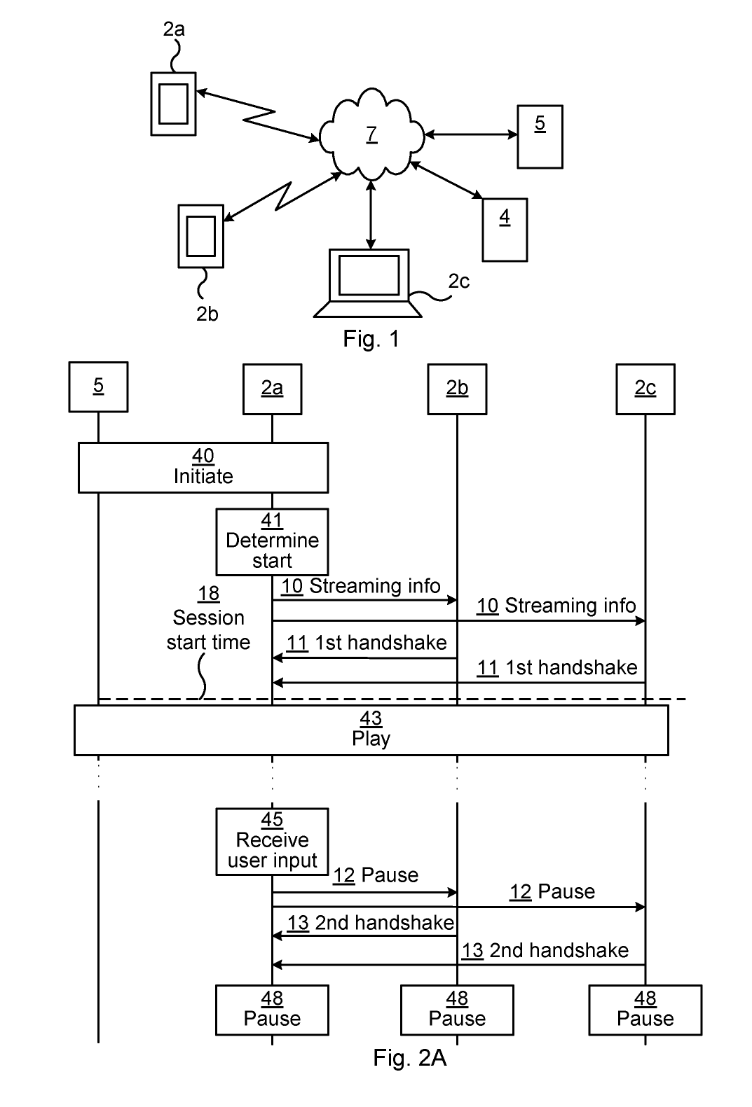

FIG. 1 is a schematic diagram illustrating an environment where embodiments presented herein may be applied. In this example, there is a first streaming client 2a, a second streaming client 2b and a third streaming client 2c. All three streaming clients 2a-c are connected to a content server 5 and optionally to each other via a network 7. The network 7 can be a local area network (LAN) or a wide area network (WAN) such as the Internet. The connection between the streaming clients 2a-c and the network can be wireless or wire based.

In this example, the first streaming client 2a and the second streaming client 2b are mobile devices, such as a mobile phone, a smart phone or a tablet/laptop computer, and are connected to the network 7 using a wireless connection. The wireless connection can be in accordance with a cellular network standard, such as any one or a combination of LTE-SAE (Long Term Evolution—System Architecture Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced. Alternatively or additionally, the wireless connection can be in accordance with a wireless local area network standard, such as any one of the IEEE 802.11x standards. Alternatively or additionally, the wireless connection can be in accordance with short distance wireless communication standards, such as Bluetooth, ZigBee, etc.

The third streaming client 2C is here a fixed device, such as a stationary computer, and is connected to the network using a wire based connection. The wired connection can e.g. be a local area network connection such as an Ethernet connection, and/or a local connection such as a USB (Universal Serial Bus) connection or FireWire connection. The wired connection can also comprise a connection between a facility and an Internet service provider, e.g. using DSL (Digital Subscriber Line), coaxial cable (also used for cable television) and/or an optical fibre.

The content server 5 provides media streams of streaming content to one or more of the streaming clients 2a-c, using any suitable delivery protocol. The phrase streaming content, whenever used herein, relates to the piece of content, e.g. a film, a television programme or a sporting event. The phrase media stream, whenever used herein, relates to the media stream of a streaming content which can be received by a streaming client. For example, the first streaming client 2a can receive a media stream of a particular streaming content and the second streaming client 2b can receive a media stream of the same streaming content. It is to be noted that the media streams of a single streaming content can differ e.g. in bitrate (e.g. in different representations), file format, encoding and/or delivery protocol, as long as media streams both relate to the same streaming content.

Examples of file formats for the media streams are ISO BMFF (International Organization for Standardization Base Media File Format) or MPEG2-TS (Moving Picture Experts Group 2 Transport Stream). Examples of encoding are H.264, H.265 (High Efficiency Video Coding), MPEG4 (Moving Picture Experts Group 4), AAC (Advanced Audio Coding), and or MP3 (MPEG-1 or MPEG-2 Audio Layer III).

Examples of delivery protocols can e.g. be based on adaptive HTTP (Hypertext Transfer Protocol) streaming (AHS) such as Apple HTTP Live Streaming (HLS), Microsoft SmoothStreaming (ISM), 3GP (Third Generation Partnership) DASH (Dynamic Adaptive Streaming over HTTP), MPEG-DASH, Adobe Dynamic Streaming, etc. Alternatively or additionally, there are delivery protocols such as RTSP/RTP (Real-time Streaming Protocol/Real-time Transport Protocol), etc.

The embodiments presented herein may be applied with any suitable current or future file format, encoding and delivery protocol and are not limited to the examples mentioned herein.

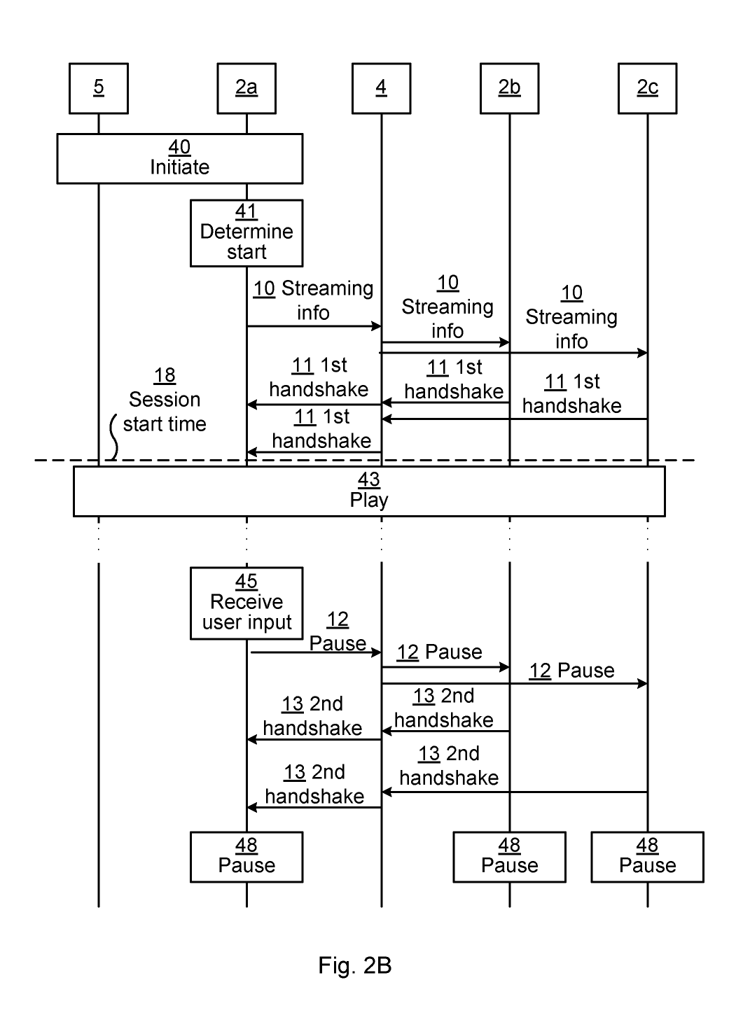

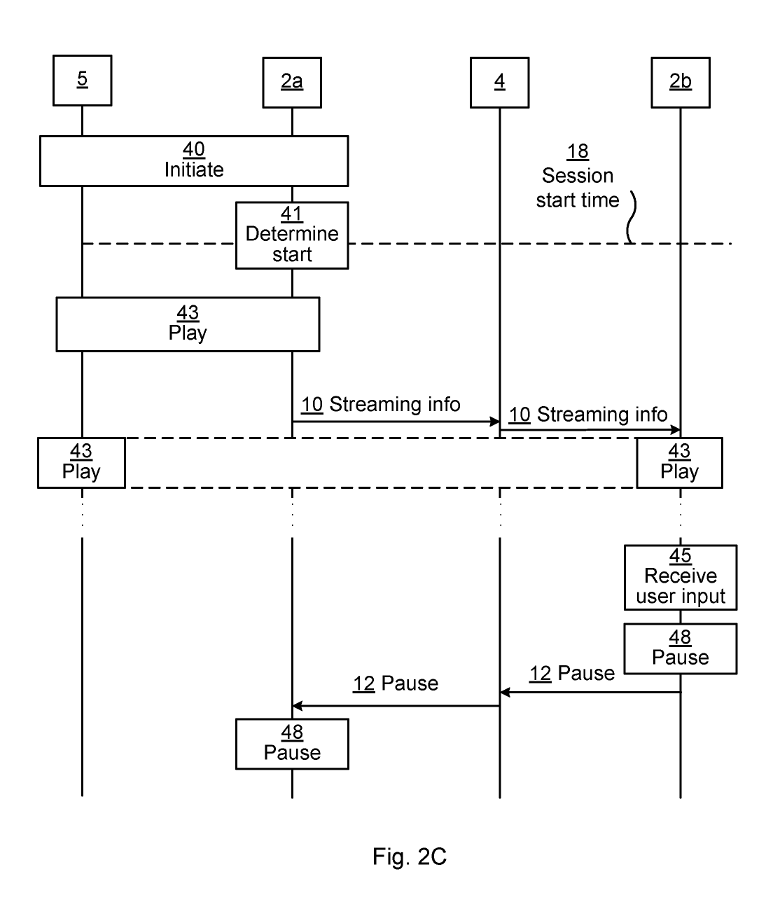

Optionally a message broker 4 is provided in contact with the network 7, to facilitate exchange of messages between the streaming clients 2a-c for synchronisation of playing of streaming content, as described in more detail with reference to FIGS. 2B-C below.

The message broker 4 can be a server or other type of communication channel. For example, the message broker could be an IP (Internet Protocol) network service, a multicast carousel, an IRC (Internet Relay Chat) channel, etc.

FIGS. 2A-C are sequence diagrams illustrating communication between the components/devices of FIG. 1 for synchronising playing of streaming content in various embodiments. Each example concerns one session of synchronised streaming involving one initiating streaming client and at least one following streaming client for a particular streaming content from the content server 5. This synchronisation of streams across multiple streaming clients provides a social aspect of consuming streaming content which hitherto has only been available for broadcast or multicast content. There is no need for difficult manual synchronisation, e.g. “start playing the video clip exactly now”, since this is covered by the presented explicit messaging between streaming clients. Moreover, the presented embodiments are solved using communication between streaming clients and thus not requiring any central coordination. This allows on-demand content from different sources to be synchronised, as long as there is a common identifier of the streaming content.

Looking first to FIG. 2A, this sequence diagram shows an example involving the first streaming client 2a, the second streaming client 2b and the third streaming client 2c of FIG. 1. In this example, the first streaming client 2a is an initiating streaming client, the second streaming client 2b is a following streaming client and the third streaming client is a following streaming client. It is to be noted, however, that the roles are interchangeable. For instance, in another scenario, the second streaming client 2b can be the initiating streaming client, etc. The initiating streaming client is the one that determines the session start time 18 and all other streaming clients are following clients.

In an initiate step 40, the first streaming client 2a initiates the media stream of the streaming content for itself in communication with the content server 5. For example, this may include receiving metadata of the streaming content, selecting a particular delivery mechanism, encoding and/or bitrate. Optionally, this may include sending a setup command to a node associated with the content server housing the streaming content.

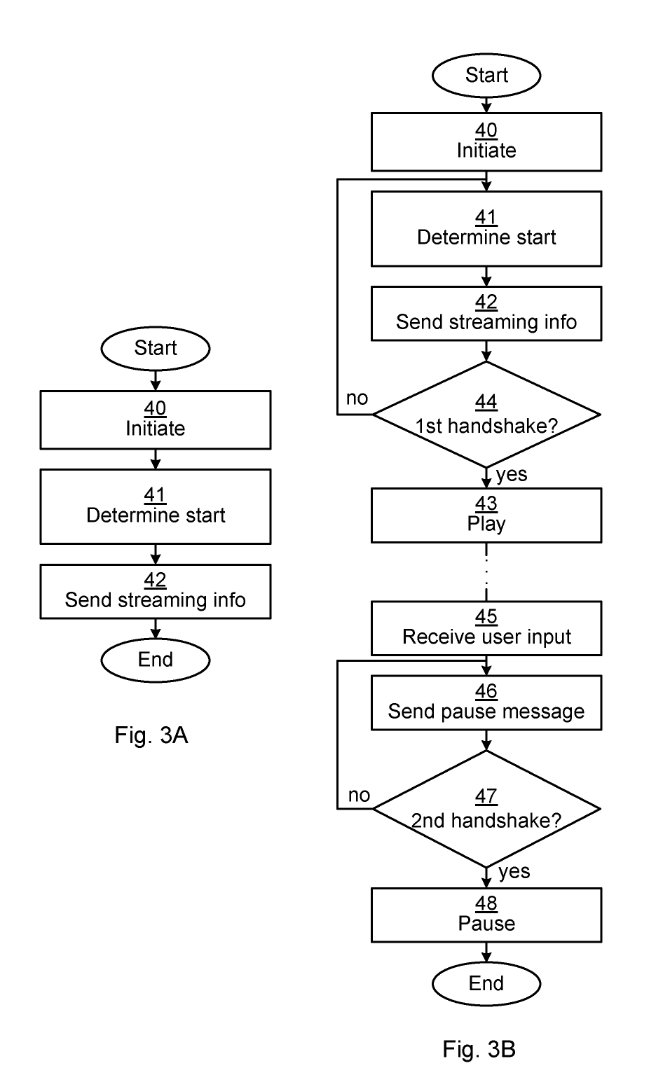

In a determine start step 41, a session start time 18 is determined. The session start time 18 defines a time after which a media stream of the media content should be played for any streaming client having access to the session start time 18. This step is described in more detail with reference to FIG. 3A below.

Once the session start time 18 is determined, the first streaming client 2a sends a streaming info message 10 to the following streaming clients, i.e. the second streaming client 2b and the third streaming client 2c. The streaming info message 10 comprising an identifier of the streaming content and the session start time 18. This defines a time line of the streaming, allowing the position in the stream to be determined after the session start time 18 by determining the difference between a current time and the session start time 18. Clocks of the streaming clients 2a-c are essentially synchronised. Such synchronisation can e.g. be achieved using NTP (Network Time Protocol).

The communication from one streaming client to another can e.g. occur using websocket via HTTP, HTTP or direct IP messages. In one embodiment, IP multicast is used for this communication. Alternatively polling e.g. over HTTP or FTP (File Transfer Protocol), can be used. For example, when websocket over HTTP is used, HTTP is used for an initial handshake, after which the communication switches to websocket which does not need to follow HTTP. Nevertheless, the websocket communication occurs over the same TCP (Transmission Control Protocol) ports as the initial HTTP handshake. In such a case the streaming info message 10 may be a websocket message. When polling over HTTP is used, the first streaming client 2a runs an HTTP server. In such a case, the second and third streaming clients 2b, 2c each send an HTTP GET (or POST) request to the first streaming client 2a, which then responds to each one of the second and third streaming clients 2b, 2c with an HTTP response (with a response code of 200 OK) which is then the streaming info message 10.

Optionally, the second streaming client 2b and the third streaming client 2c acknowledge receipt of the streaming info message 10 with a respective first handshake message 11 for increased reliability. For instance, when websocket is used, the first handshake message 11 can be a TCP acknowledgement. When HTTP polling is used, the first handshake message 13 can e.g. be in the form of a new HTTP POST or GET request. When pure HTTP is used, the first handshake message 11 can be in the form of an HTTP 200 OK response.

Once the session start time 18 has passed, the first streaming client 43 starts to play the media stream of the streaming content from the content server 5 in a play step 43. Around the same time, the second streaming client 2b and the third streaming client 2c also start to play 43 their respective media streams of the streaming content from the content server 5.

In this way, all these streaming clients 2a-c play their respective media streams of the streaming content synchronously. The users of the streaming clients 2a-c can interact socially in parallel over another channel, e.g. using a phone call, a video call, instant messaging, etc.

Optionally, pausing is also synchronised in a similar way to the playing. This will now be described in an example where the first streaming client 2a is the client which initiates the pausing. In one embodiment, it is only the initiating client, i.e. the first streaming client 2a in this example, which is allowed to initiate pausing of content. In another embodiment, any streaming client forming part of the same set of synchronised streaming clients may initiate the pausing (shown in FIG. 2C and described below).

The first streaming client 2a receives a user input in a receive user input step 45 to pause the playing of the media stream. The first streaming client 2a then sends a pause message 12 to all following streaming clients, in this example the second streaming client 2b and the third streaming client 2c.

Optionally, the second streaming client 2b and the third streaming client 2c acknowledge receipt of the pause message 12 with a respective second handshake message 13 for increased reliability. For instance, when websocket is used, the second handshake message 13 can be a TCP acknowledgement. When HTTP polling is used, the second handshake message 13 can e.g. be in the form of a new HTTP POST or GET request. When pure HTTP is used, the second handshake message 13 can be in the form of an HTTP 200 OK response.

When the second handshake message 13 is utilised, i.e. sent from the second and third streaming clients and received by the first streaming client, the first streaming client 2a pauses the media stream only when the second handshake message 13 has been received from all the following streaming clients 2b, 2c.

When the second handshake message 13 is not utilised, i.e. when the acknowledgement is not required, the first streaming client 2a pauses the media stream when the pause message 12 has been sent to the following streaming clients 2b, 2c. Optionally, this involves communication with the content server 5, e.g. in the case of RTSP/RTP.

It is to be noted that while, in this example, it happens to be same client that determines the session start time 18 and that initiates the pausing, the pausing can be initiated by any one of the streaming clients 2a-c.

When the media stream is to be started again, a new streaming info message 10 is sent, defining a new time line, e.g. including a session re-start time, for the streaming of the streaming content. The session re-start time corresponds to the session start time 18 but also comprises a timecode of the content which corresponds to the restart time.

Any streaming client can (re)synchronise to the content stream at any time by determining a current position in the stream simply by taking its current time and subtracting the session (re)start time.

FIG. 2B shows an example equivalent in functionality of the example of FIG. 2A. However, here the message broker 4 of FIG. 1 is utilised to facilitate communication between the streaming clients.

The communication between the streaming clients 2a-c and the message broker 4 can e.g. occur using websocket via HTTP, HTTP or direct IP messages. In one embodiment, IP multicast is used for this communication. Alternatively polling e.g. over HTTP or FTP (File Transfer Protocol), can be used.

The first streaming client 2a sends the streaming info message 10 only to the message broker 4, e.g. in the form of a websocket message, HTTP GET or POST request, an HTTP response (to a polling) or a direct IP message. The message broker 4 then in turn sends the streaming info message 10 to the the second streaming client 2b and the third streaming client 2c, e.g. in the form of a websocket message, HTTP GET or POST request or a direct IP message. It is to be noted that the streaming info message 10 to the message broker does not need to be identical to the streaming info message 10 from the message broker, as long as they both contain the identifier of the streaming content and the session start time. Also, the first handshake messages 11 are first sent from the second and third streaming clients 2b, 2c to the message broker 4. The first handshake message is e.g. in the form of an TCP acknowledgement, a new MIT GET or POST request, or an HTTP 200 OK response. The message broker then sends the first handshake messages 11 to the first streaming client 2a, e.g. in the form of an TCP acknowledgement, a new HTTP GET or POST request, or an HTTP 200 OK response.

Analogously, when the pause message 12 is utilised, this is first sent by the first streaming client 2a to the message broker 4. The pause message 12 can e.g. in the form of a websocket message, HTTP GET or POST request, an HTTP response (to a polling) or a direct IP message. The message broker 4 then in turn sends the pause message 12, e.g. in the form of a websocket message, HTTP GET or POST request, an HTTP response (to a polling) or a direct IP message, to the second streaming client 2b and the third streaming client 2c. Also, when utilised, the second handshake messages 13 are first sent from the second and third streaming clients 2b, 2c to the message broker 4. The first handshake message is e.g. in the form of an TCP acknowledgement, a new MIT GET or POST request, or an HTTP 200 OK response. The message broker then sends the second handshake messages 13 to the first streaming client 2a, e.g. in the form of an TCP acknowledgement, a new HTTP GET or POST request, or an HTTP 200 OK response.

The message broker 4 can keep track of the streaming clients associated with a session, implementing a star topology for the communication. In this way, the streaming clients 2a-c only need to communicate with the message broker 4 and the message broker then forwards the communication as needed to other streaming clients of the session.

The message broker 4 can optionally store the streaming info message 10. This allows new streaming clients to join an ongoing session. The new streaming client then checks its clock and determines at what point the media stream should be started to be in synchronisation with the session.

In FIG. 2C an embodiment is shown wherein the session start time is determined differently to what is shown if FIGS. 2A-B. Moreover, in this example, there is here only one following streaming client in the form of the second streaming client 2b.

Here, in the determine start step 41, the session start time 18 is determined to be the time of when the determine start step 41 is performed. In this way, the play step 43 is performed right after the determine start step, since the play step is performed once the session start time 18 has passed. This minimises any delay for the first streaming client 2a to start playing the media stream.

After this, the streaming info message 10 is sent to the second streaming client 2b (here via the message broker 4). Once the second streaming client 2b receives the streaming info message with the session start time being in the past, it determines the current position in its media stream of the streaming content and starts playing the media stream in synchronicity with the playing of the first streaming client 2a. The current position can be determined by taking the current time and subtracting the session start time.

In this example, the second streaming client 2b receives the user input in the receive user input step 45. The second streaming client 2b pauses its media stream without delay in the pause step 48 and sends the pause message 12 to the first streaming client 2a via the message broker 4.

FIGS. 3A-B are flow charts illustrating embodiments of methods for synchronising playing of streaming content. The methods are used to synchronise playing of streaming content between an initiating streaming client and a following streaming client and correspond to the examples shown in the sequence diagrams 2A-C and described above. The initiating streaming client initiates the session for the streaming content among a set of streaming clients. The following streaming client joins this session as defined by the initiating streaming client. The methods are performed by the initiating streaming client (see 2a of FIGS. 2A-C) and are performed for a particular instance of streaming content (audio and/or video). While the methods are mainly described with reference to a single following streaming client, the methods can be applied analogously for two, three or more following streaming clients. First, the method illustrated in FIG. 3A will be described.

In an initiate step 40, streaming of a media stream of the streaming content is initiated to the initiating streaming client. The media stream can e.g. be a unicast stream(i.e. an on-demand stream), which increases the need of synchronising the playing of the streaming content across streaming clients. Optionally, the media stream is stored locally in a memory of the initiating streaming client.

In a determine start step 41, a session start time is determined. The session start time defines a time after which the media stream is to be started to be played by any client having access to the session start time.

The session start time can for instance be determined by adding a guard time period to a current time. The guard time should be sufficiently long to allow other clients to receive the streaming info, set up the streaming and start playing. In this way, the initiating client and the following client should be able to start playing the content at essentially the same time.

In one embodiment, the session start time can be set to a time of when the media stream becomes available to the initiating streaming client. For example, if the media stream relates to a sport event which starts at 6 p.m. today, then the session start time can be set to that time, whereby the initiating client and the following client both start playing the content at essentially the same time, i.e. the time of when the media stream becomes available.

In one embodiment, this step comprises determining the session start time to be the current time. This will allow the initiating client to start playing the content quickly. The following streaming client will start playing the content as soon as it has received the session start time, with an offset such that the media stream is played essentially synchronously for the initiating streaming client and the following streaming client.

In a send streaming info step 42, a streaming info message is sent for distribution to the following streaming client. The streaming info message can be sent directly to the following streaming client as shown in FIG. 2A and described above or via the message broker as shown in FIGS. 2B-C and described above. The streaming info message comprises an identifier of the streaming content and the session start time. This allows the following streaming client to set up a media stream for the same streaming content. It is to be noted that the media streams can differ in quality and/or format between the initiating streaming client and the following streaming client, as long as media streams both relate to the same streaming content, e.g. programme, event or film.

Optionally, the streaming clients re-synchronise (not shown) by sending messages to each other after a certain time.

FIG. 3B illustrates a method similar to the method of FIG. 3A. Only steps that are new or that differ from what is described with reference to FIG. 3A will be described here.

After the send streaming info step 42, there is here an optional conditional first handshake step 44. In the conditional first handshake step 44, it is determined whether the first handshake (see 11 of FIGS. 2A and 2B) has been received. The first handshake message indicates that the following streaming client has received the streaming info message. When it is determined that the first handshake message has been received, the method proceeds to a play step 43. Otherwise, the method returns to the determine start step 41 to determine a new session start time and send this in a new streaming info message to the following streaming client. In one embodiment, the new session start time is determined with a greater guard time than the previous iteration of the determine start step 41. Optionally, the method returns to the determine start step 41 only when the first handshake message has not been received within a specific time after the streaming info message was sent.

In the play step 43, playing of the media stream is started once the session start time has passed. After this step, time passes when the media stream is played on the initiating streaming client and the corresponding media stream is played on the following streaming client.

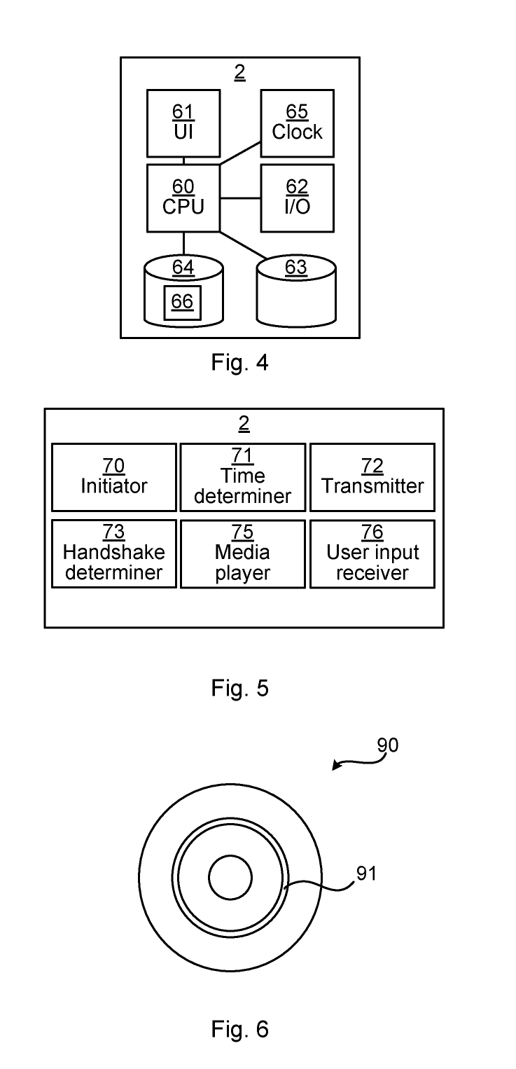

In an optional receive user input step 45, user input is received to pause the media stream. This user input is received through the user interface (see 61 of FIG. 4) of the initiating streaming client, e.g. using a touch sensitive display, keyboard, pointing device, etc.

In an optional send pause message step 45, a pause message (see 12 of FIGS. 2A and 2B) is sent for distribution to the following streaming client, either directly or via the message broker. In one embodiment, the pause message is sent in response to receiving user input to pause. In one embodiment, the pause message is sent when rebuffering is needed for the streaming client in question. The pause message comprises an identifier of the streaming content. The identifier can be a direct identifier of the streaming content or an identifier of the session between the initiating streaming client and the following streaming client.

After the send pause message step 46, there is an optional conditional second handshake step 47. In the conditional second handshake step 47, it is determined whether the second handshake (see 13 of FIG. 2A and FIG. 2B) has been received. The second handshake message indicates that the following streaming client has received the pause message. When it is determined that the second handshake message has been received, the method proceeds to a pause step 48. Otherwise, the method returns to the send pause message step 46 to again send the pause message to the following streaming client.

In the optional pause step 48, the media stream is paused.

FIG. 4 is a schematic diagram showing some components of a streaming client 2 representing each one of the streaming clients 2a-c of FIG. 1. The streaming client 2 is arranged to execute the methods of FIGS. 3A-B. A processor 60 is provided using any combination of one or more of a suitable central processing unit (CPU), multiprocessor, microcontroller, digital signal processor (DSP), application specific integrated circuit etc., capable of executing software instructions contained in a computer program 66 stored in a non-transitory computer program storage product 64, e.g. in the form of a memory, but not in the form of a signal or any form of electromagnetic wave. The processor 60 can be configured to execute the method described with reference to FIGS. 3A-B above.

The memory 64 can be any combination of read and write memory (RAM) and read only memory (ROM). The memory 64 also comprises persistent storage, which, for example, can be any single one or combination of magnetic memory, optical memory, solid state memory or even remotely mounted memory.

A data memory 63 is also provided for reading and/or storing data during execution of software instructions in the processor 60. The data memory 63 can be any combination of read and write memory (RAM) and read only memory (ROM) and may also comprise persistent storage, which, for example, can be any single one or combination of magnetic memory, optical memory, solid state memory or even remotely mounted memory.

The streaming client 2 further comprises an I/O interface 62 for communicating with other external entities, such as the network 7 of FIG. 1 using a wireless connection and/or a wire based connection.

A clock 65 is used for keeping track of time, which can be used with the session start time 18 as described above.

A user interface 61 e.g. a display (optionally touch sensitive), keys, microphone, speaker, pointing device (such as a mouse or track pad) etc. The display and/or speaker of the user interface 61 can be used when playing the media stream as described above. Moreover, the user interface 61 can be used to receive user input for controlling the media stream, e.g. playing or pausing, as described above.

Other components of the streaming client 2 are omitted in order not to obscure the concepts presented herein.

FIG. 5 is a schematic diagram showing functional modules of the streaming client 2 of FIG. 4. The modules are implemented using software instructions such as a computer program executing in the streaming client 2. The modules correspond to the steps in the methods illustrated in FIGS. 3A-B, and may or may not correspond also to programme modules, but as known to the skilled person does not have to be programme modules in some programming languages.

An initiator 70 is arranged to initiate streaming of the media stream of the streaming content. This module corresponds to the initiate step 40.

A time determiner 71 is arranged to determine a session start time after which the media stream is to be started to be played by any client having access to the session start time. This module corresponds to the determine start step 41.

A transmitter 72 is arranged to send the streaming info message for distribution to the following streaming client. Moreover, the transmitter 72 is optionally arranged to send a pause message. This module corresponds to the send streaming info step 42 and the send pause message step 46.

An optional handshake determiner 73 is arranged to determine when the first handshake message has been received and/or when the second handshake message has been received. This module corresponds to the conditional first handshake step 44 and the conditional second handshake step 47.

A media player 75 is arranged to play, and optionally pause, the media stream of the streaming content using the user interface of the streaming client. This module corresponds to the play step 43 and the pause step 48.

A user input receiver 76 is arranged to receive user input e.g. to pause the media stream. This module corresponds to the receive user input step 45.

FIG. 6 shows one example of a computer program product 90 comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 64 of FIG. 4 or as a removable solid state memory, e.g. a flash storage memory. While the computer program 91 is here schematically shown as a track on the depicted optical disk, the computer program can be stored in any way which is suitable for the computer program product.

The invention has mainly been described above with reference to a few embodiments. However, as is readily appreciated by a person skilled in the art, other embodiments than the ones disclosed above are equally possible within the scope of the invention, as defined by the appended patent claims.

1. A method for synchronising playing of streaming content between an initiating streaming client and a following streaming client, the method being performed by the initiating streaming client and comprising the steps of:
initiating streaming of a media stream of the streaming content to the initiating streaming client;
determining a session start time after which the media stream is to be started to be played by any client having access to the session start time; and
sending a streaming info message for distribution to the following streaming client, the streaming info message comprising an identifier of the streaming content and the session start time,
wherein the media stream is a unicast media stream.

2. An initiating streaming client for synchronising playing of streaming content between the initiating streaming client and a following streaming client, the initiating streaming client comprising:
a processor; and
a memory storing instructions that, when executed by the processor, causes the initiating streaming client to:
initiate streaming of a media stream of the streaming content to the initiating streaming client;
determine a session start time after which the media stream is to be started to be played by any client having access to the session start time; and
send a streaming info message for distribution to the following streaming client, the streaming info message comprising an identifier of the streaming content and the session start time,
wherein the media stream is a unicast media stream.

3. The initiating streaming client according to claim 2, wherein the instructions to determine a session start time comprise instructions that, when executed by the processor, causes the initiating streaming client to determine the session start time by adding a guard time period to a current time.

4. The initiating streaming client according to claim 2, wherein the instructions to determine a session start time comprise instructions that, when executed by the processor, causes the initiating streaming client to determine the session start time to be a time of when the media stream becomes available to the initiating streaming client.

5. The initiating streaming client according to claim 2, comprising instructions that, when executed by the processor, causes the initiating streaming client to:
start to play the media stream once the session start time has passed.

6. The initiating streaming client according to claim 2, comprising instructions that, when executed by the processor, causes the initiating streaming client to:
determine when a first handshake message has been received, the first handshake message indicating that the following streaming client has received the streaming info message within a specific time.

7. The initiating streaming client according to claim 6, comprising instructions that, when executed by the processor, causes the initiating streaming client to:
re-execute the instructions to determine a session start time when the first handshake message has not been received.

8. The initiating streaming client according to claim 2, comprising instructions that, when executed by the processor, causes the initiating streaming client to:
receive user input to pause the media stream; and
send a pause message for distribution to the following streaming client, the pause message comprising an identifier of the streaming content.

9. The initiating streaming client according to claim 2, comprising instructions that, when executed by the processor, causes the initiating streaming client to:
determine when a second handshake message has been received, the second handshake message indicating that the following streaming client has received the pause message.

10. The initiating streaming client according to claim 8, comprising instructions that, when executed by the processor, causes the initiating streaming client to:
pause the media stream.

11. The initiating streaming client according to claim 2, wherein the instructions to determine a session start time comprise instructions that, when executed by the processor, causes the initiating streaming client to determine the session start time to be the current time.

12-23. (canceled)

24. A non-transitory computer program product comprising a computer program for synchronising playing of a media stream between an initiating streaming client and a following streaming client, the computer program comprising computer program code which, when run on the initiating streaming client causes the initiating streaming client to:
initiate streaming of the media stream to the initiating streaming client;
determine a session start time after which the media stream is to be started to be played by any client having access to the session start time; and
send a streaming info message for distribution to the following streaming client the streaming info message comprising an identifier of the media stream and the session start time,
wherein the media stream is a unicast media stream.

25. (canceled)
